(19) United States
(12) Patent Application Publication
(10) Pub. No.: US 2006/0262241 A1
(43) Pub. Date: Nov. 23, 2006

(54) Plasma display device

(76) Inventor: Kwang-Jin Jeong, Yongin-si (KR)

Correspondence Address: Robert E. Bushnell, Suite 300, 1522 K Street, N.W., Washington, DC, 20005, US

(21) Appl. No.: 11/430,200

(22) Filed: May 9, 2006

(30) Foreign Application Priority Data
May 14, 2005 (KR) 10-2005-0040423

(51) Int. Cl. G02F 1/1333

(52) U.S. Cl. 349/58; 362/373

(57) ABSTRACT

In a plasma display device, a coupling structure for coupling front and rear covers is modified so that an empty space is formed between the front and rear covers, and a heat sink making contact with a driving chip of a signal line connecting an electrode of a display panel with a driving circuit extends along the empty space, thereby improving the heat dissipation efficiency of the driving chip.

### CLAIM OF PRIORITY

This application makes reference to, incorporates the same herein, and claims all benefits accruing under 35 U.S.C. § 119 from an application for PLASMA DISPLAY DEVICE, earlier filed in the Korean Intellectual Property Office on the 14^{th} of May 2005 and there, duly assigned Serial No. 10-2005-0040423.

### BACKGROUND OF THE INVENTION

1. Technical Field

The present invention relates to a plasma display device. More particularly, the present invention relates to a plasma display device capable of improving heat dissipation characteristics of a driving chip provided on a signal line connecting an electrode of a plasma display panel to a driving circuit for driving the electrode.

2. Related Art

As generally known in the art, a plasma display device refers to a flat display device using a plasma display panel (PDP) which can be obtained through the procedure of forming electrodes on two opposite substrates, respectively, overlapping the substrates with each other so that a predetermined space is formed therebetween, injecting discharge gas into the space, and sealing the space. Hereinafter, the plasma display panel (PDP) can also be referred to as a “panel”.

In contrast to a cathode ray tube (CRT) having a large volume, the plasma display device can be fabricated with a slim structure so that the plasma display device is adaptable for obtaining a large-sized screen having a light weight and a relatively small volume. In addition, in contrast to other flat display devices, the plasma display device does not require an active element, such as a transistor, and can ensure wide viewing angles and a high degree of brightness.

After preparing the plasma display panel, elements required for displaying an image, such as driving circuits connected to the electrodes of the plasma display panel, are installed on the plasma display panel, thereby achieving the plasma display device. In the above plasma display panel, each pixel generates light in a pixel area. That is, plasma or excited atoms are generated in the pixel area by means of the pixels as a voltage is applied to electrodes. Some of the power used for plasma discharge is converted into light, but most of the power is consumed while being converted into heat in the plasma display panel. However, fluorescent materials used for fabricating the plasma display panel may be degraded or deformed as the temperature thereof rises so that the life span of the plasma display panel may be shortened. In addition, when the plasma display panel is overheated, in particular, when the plasma display panel is locally overheated, a glass substrate of the plasma display panel may be thermally expanded so that the glass substrate is subject to stress, resulting in breakage of the glass substrate.

The driving circuit connected to the electrodes of the plasma display panel may consume great power in order to realize an image. The power consumption results in heat generation, and if the driving circuit becomes overheated, it may malfunction. For instance, some pixel parts may generate light even if they are not expected to generate light, thereby degrading the image quality. For this reason, it is an important technical object for the plasma display device to effectively dissipate heat generated from driving circuits and the like. In particular, heat dissipation may become a serious problem in some parts of the plasma display device, such as a driving chip of a tape carrier package (TCP), on which heat is concentrated so that a separate heat sink must be provided to cool the parts.

### SUMMARY OF THE INVENTION

Accordingly, the present invention has been developed in order to solve one or more of the above-mentioned problems, and an object of the claimed invention is to provide a plasma display device capable of improving heat dissipation characteristics of a driving chip provided on a signal line by allowing a heat sink having a heat-conductive relationship with respect to the driving chip to extend in a predetermined direction without interfering with driving circuits.

In order to accomplish the above object, the present invention provides a plasma display device comprising: a plasma display panel installed at an inner portion of the front and rear covers; a chassis attached to a rear surface of the plasma display panel, and including a chassis base and a reinforcement member; a driving circuit installed on a rear surface of the chassis for driving the plasma display panel; a signal line connecting the driving circuit to an electrode terminal installed at a peripheral area of the plasma display panel, and having a driving chip; and a heat sink having a heat-conductive relationship with the driving chip in order to cool the driving chip of the signal line; wherein the heat sink extends toward an outer portion of the plasma display panel in opposition to the driving circuit through an empty space formed between the front and rear covers.

According to the exemplary embodiment of the present invention, an outer peripheral portion of the rear cover is parallel to the front cover so as to form the empty space through which the heat sink extends. A lower end portion of the rear cover is downwardly bent and overlapped with a lower end of the front cover so that the lower end portion of the rear cover surrounds the lower end portion of the front cover, and a screw is screw-coupled into an overlapped part between the front and rear covers in order to couple the front cover to the rear cover.

The heat sink is installed on a cover plate for protecting the signal line having the driving chip, and the driving chip is supported by a reinforcement member of the chassis while being interposed between the reinforcement member and the cover plate. At this point, the heat sink is installed on the cover plate so that the driving chip is positioned in correspondence with a center portion of the heat sink. In addition, heat-conductive mediums are interposed between the driving chip and the reinforcement member of the chassis, and between the driving chip and the cover plate, respectively.

Preferably, the heat sink is made of aluminum, and a plurality of upright-type cooling fins are provided on one surface of the heat sink, which does not make contact with the cover plate. The heat sink is installed on the cover plate in correspondence with a convection current direction of air generated from the front and rear covers.

In addition, the chassis base is made of steel or plastic. In this case, the cooling efficiency for the driving chip can be significantly improved due to an increase in the length of the heat sink.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded oblique view of a plasma display device;

FIG. 2 is a section view illustrating an installation state of a heat sink;

FIG. 3 is an exploded oblique view of a plasma display device according to an embodiment of the present invention; and

FIG. 4 is a section view illustrating an installation state of a heat sink according to an embodiment of the present invention.

### DETAILED DESCRIPTION OF THE INVENTION

Hereinafter, embodiments of the present invention will be described with reference to the accompanying drawings. In the following description and drawings, the same reference numerals are used to designate the same or similar components so that repetition of descriptions of the same or similar components will be omitted.

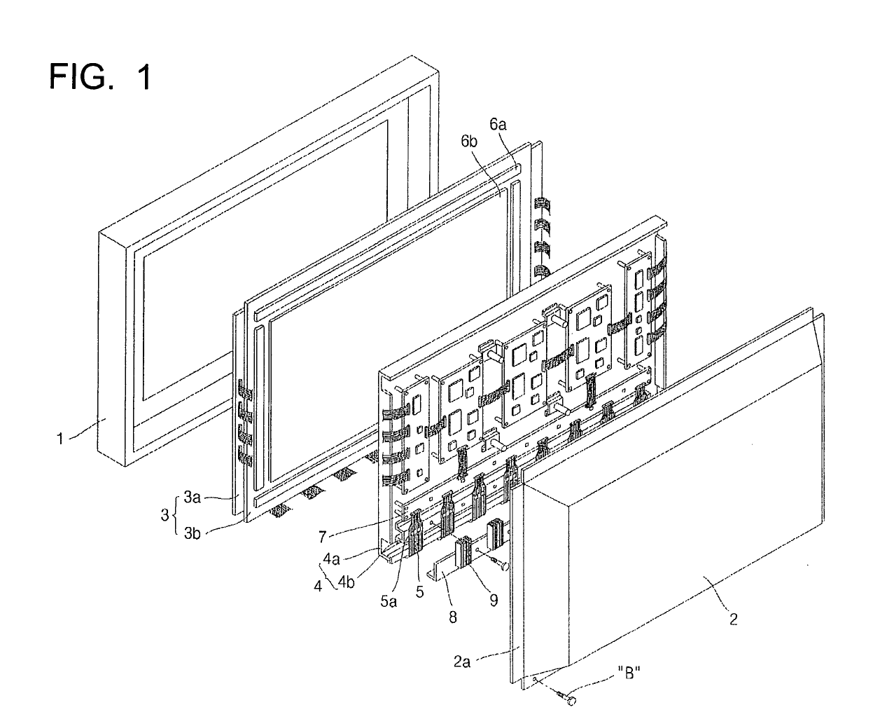

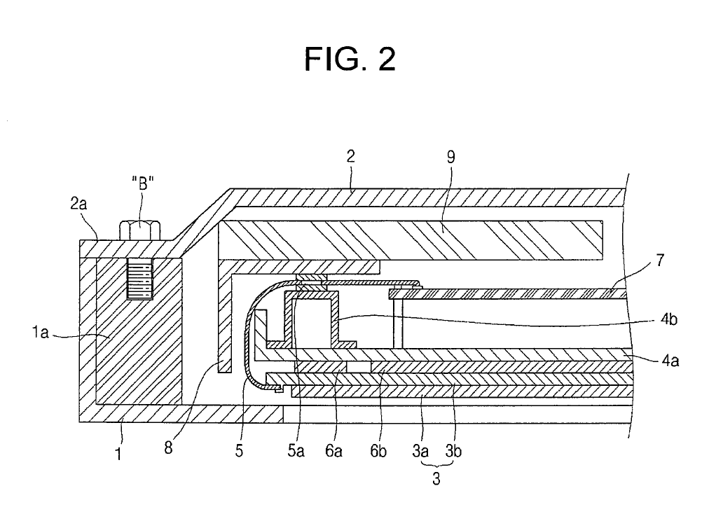

FIG. 1 is an exploded oblique view of a plasma display device, and FIG. 2 is a section view illustrating an installation state of a heat sink.

Referring to FIGS. 1 and 2, a plasma display device includes a front cover 1, a rear cover 2 coupled to the front cover 1 while forming a predetermined space therebetween, a panel 3 including front substrate 3a and rear substrate 3b and installed in the predetermined space, and a chassis 4 installed at a rear portion of the panel 3 in order to support the panel 3.

In general, the chassis 4 includes a plate-shaped chassis base 4a and a reinforcement member 4b coupled to the chassis base 4a. The chassis base 4a is fixed to a rear surface of the rear substrate 3b of the panel by means of a double sided tape 6a, and a heat conductive medium 6b is interposed between the chassis base 4a and the rear substrate 3b. In addition, a plurality of IC chips and circuit elements are distributed on a plurality of circuit boards 7 at the rear surface of the chassis base 4a, and are connected to a power source (not shown) in order to drive the panel. The circuit boards 7 are spaced apart from the chassis base 4a by means of bosses (not shown) installed in the chassis base 4a.

That is, the chassis base 4a supports the panel 3 in order to reinforce the mechanical strength of the panel 3. In addition, the chassis base 4a emits heat by receiving the heat from the panel or the driving circuit making contact with the chassis 4, and dissipates the heat locally concentrated in the chassis 4. To this end, the chassis base 4a is generally fabricated by using a metal having superior heat conductivity, such as aluminum.

A chip on film (COF) or a TCP 5 having a driving chip 5a is used as a signal transfer unit for connecting a signal electrode connected to the pixel formed on the panel of the plasma display device to a driving circuit for driving the signal electrode. In contrast to other driving circuit elements, the driving chip provided in the TCP or the COF is not installed on the circuit board, but is installed on a signal line connecting the electrode of the panel to the driving circuit unit. Thus, the driving chip provided in the TCP or the COF may generate a great amount of heat, which is not directly dissipated to the atmosphere. For this reason, the driving chip 5a is supported by the reinforcement member 4b of the chassis 4, and is aligned between the reinforcement member 4b and a cover plate 8 while making contact with the reinforcement member 4b and the cover plate 8 so as to dissipate the heat.

In addition, a heat sink 9 is installed on an upper surface of the cover plate 8. One end of the heat sink 9 makes surface-contact with the cover plate 8, and the other end of the heat sink 9 protrudes toward the circuit boards 7 attached to the rear surface of the chassis base 4a, so that heat generated from the driving chip 5a of the TCP can be dissipated to the atmosphere through the cover plate 8.

However, according to the heat dissipation structure for the driving chip 5a of the TCP 5, the length of the heat sink 9 cannot be extended.

That is, as shown In FIG. 2, a rim part 2a is formed at an outer peripheral portion of the rear cover 2 in order to couple the rear cover 2 to the front cover 1 by means of a screw B. As a result, it is difficult to improve heat dissipation efficiency because the heat sink 9 cannot be extended in a direction opposite to the circuit boards 7. The screw B inserted into the rim part 2a of the rear cover 2 is screw-coupled with a fixing member 1a provided in the front cover 1 so that the rear cover 2 is coupled to the front cover 1.

In addition, if the heat sink 9 extends toward the circuit boards 7, the heat sink 9 may interfere with various driving circuits provided on the circuit boards 7, so that some parts of the driving circuits must be eliminated. However, if some parts of the driving circuits are eliminated, the driving waveform of the panel may become irregular and electromagnetic interference (EMI) may increase, degrading the quality of the plasma display device.

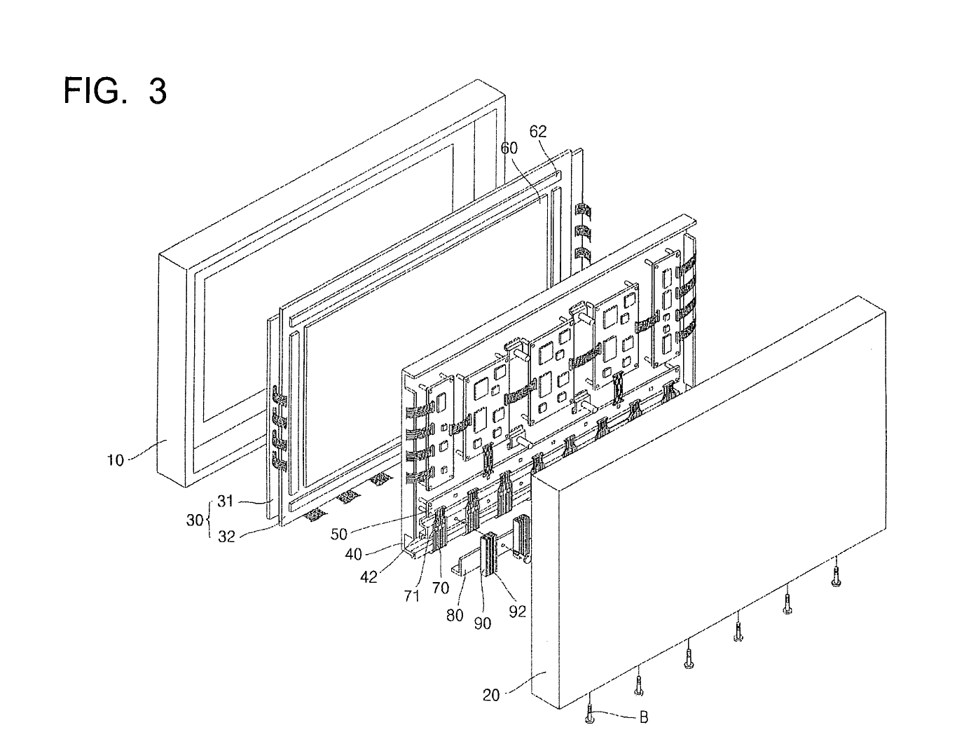

FIG. 3 is an exploded oblique view of a plasma display device according to an embodiment of the present invention. Referring to FIG. 3, the plasma display device according to an embodiment of the present invention includes a front cover 10, a rear cover 20, a panel 30 including front substrate 31 and rear substrate 32 and installed between the front cover 10 and rear cover 20, a chassis base 40 supporting the panel 30 at a rear portion of the panel 30, and a circuit board 50 installed on a rear surface of the chassis base 40 and provided with driving circuits.

Sustain electrodes (not shown) are disposed horizontally in the front substrate 31 of the panel 30, and are parallel to each other in a linear pattern. In addition, address electrodes (not shown) are disposed vertically in the rear substrate 32 of the panel 30, and are parallel to each other in a linear pattern. A barrier wall (not shown) is positioned parallel to the address electrodes, and a fluorescent layer (not shown) is aligned above the address electrodes.

A chassis is installed at a rear portion of the rear substrate 32. The chassis includes a chassis base 40 having a plate shape and a reinforcement member 42 supporting the chassis base 40 at a rear portion of the chassis base 40. The chassis base 40 is fixed to the rear surface of the rear substrate 32 by means of a double sided tape 62, and a heat conductive medium 60 is interposed, together with the double sided tape 62, between the chassis base 40 and the rear substrate 32.

Both ends of signal lines, such as a TCP 70, are connected to the circuit board 50 coupled to the chassis base 40 and the rear substrate 32 of the panel 30. In order to protect the TCP 70, a cover plate 80 is installed at an outer end of the panel 30.

A heat sink 90 is installed on the cover plate 80 in order to dissipate heat generated from a driving chip 71 of the TCP 70 interposed between the reinforcement member 42 of the chassis and the cover plate 80.

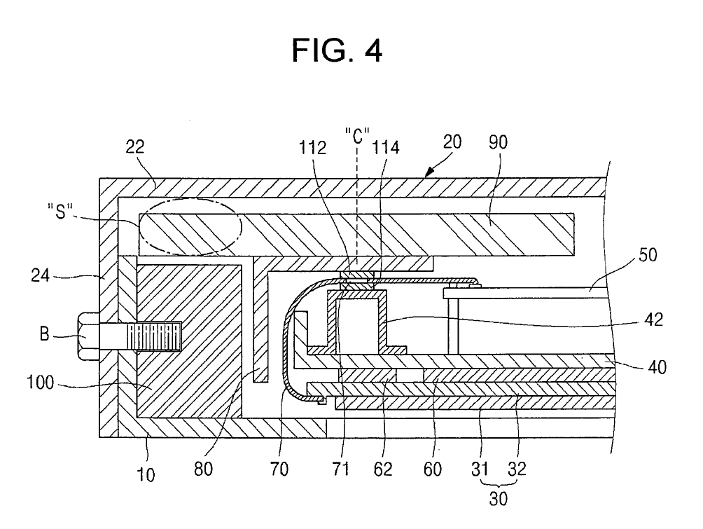

FIG. 4 is a section view illustrating an installation state of a heat sink according to an embodiment of the present invention. Referring to FIG. 4, the heat sink 90 is installed on an upper surface of the cover plate 80. At this point, a center portion C of the heat sink 90 is positioned in correspondence with the driving chip 71 of the TCP 70 interposed between the reinforcement member 42 of the chassis and the cover plate 80. That is, in contrast to a plasma display device in which the driving chip is biased toward one side of the heat sink, the driving chip 71 of the present invention is positioned in correspondence with the center portion C of the heat sink 90. Accordingly, heat generated by the driving chip 71 is constantly transferred to both ends of the heat sink 90 through the cover plate 80.

In order to allow the heat sink 90 to be easily extended toward an outer portion of the chassis base 40, a horizontal section 22 is formed at a lower end portion of the rear cover 20 in parallel with the front cover 10 so that an end portion of the heat sink 90 does not interfere with the lower end portion of the rear cover 20. In addition, a vertical section 24 is downwardly bent from an end portion of the horizontal section 22 so that the vertical section 24 surrounds a lower end portion of the front cover 10.

Thus, the lower end portion of the rear cover 20 surrounds the lower end portion of the front cover 10 while forming an empty space S between the lower end portions of the front cover 10 and rear cover 20. The heat sink 90 extends along the empty space S. Accordingly, the heat-exchange area of the heat sink 90 is enlarged so that the heat dissipation efficiency of the heat sink 90 is improved.

In a state in which the front cover 10 has been surrounded by the rear cover 20, a screw B is screw-coupled into a fixing member 100 installed in the lower end portion of the front cover 10 by passing it through the rear cover 20 so that the front cover 10 is coupled to the rear cover 20.

Cooling fins 92 are vertically installed on a rear surface of the heat sink 90, which does not make contact with the cover plate 80, while forming a predetermined interval therebetween. A front surface of the heat sink 90 is attached to an upper surface of the cover plate 80 so that the cooling fins 92 are aligned in correspondence with a convection current direction of air generated from the front cover 10 and rear cover 20. That is, the cooling fins 92 of the heat sink 90 are aligned in the longitudinal direction of the panel 30. In this case, air can easily flow through spaces formed between the cooling fins 92 while extensively making contact with the cooling fins 92, so that the cooling efficiency is improved.

In addition, plate-shaped solid-phase heat conductive mediums 112 and 114 are provided between the driving chip 71 of the TCP 70 and the chassis base 40, and between the driving chip 71 of the TCP 70 and the cover plate 80, respectively. The plate-shaped solid-phase heat conductive mediums 112 and 114 can be fabricated by using metal plates, carbon sheets or acryl resins including fillers.

Hereinafter, the heat dissipation operation for the driving chip of the TCP in the plasma display device having the above structure according to the embodiment of the present invention will be described with reference to FIGS. 3 and 4.

Upper and lower surfaces of the driving chip 71, which processes signals of the TCP 70 and generates a great amount of heat as the driving circuit operates, make contact with the cover plate 80 through the plate-shaped solid-phase heat conductive mediums 112 and 114 so that the driving chip 71 has a heat-conductive relationship with the cover plate 80. In addition, the heat sink 90 is installed on the upper surface of the cover plate 80 in such a manner that the center portion C of the heat sink 90 is positioned in correspondence with the driving chip 71 of the TCP 70, so that heat generated by the driving chip 71 of the TCP 70 is transferred to the heat sink 90 through the cover plate 80, and then the heat sink 90 emits the heat while making contact with ambient air. At this point, since the heat sink 90 has a heat-conductive relationship with the driving chip 71 through the cover plate 80, and the driving chip 71 is positioned in correspondence with the center portion C of the heat sink 90, the heat generated by the driving chip 71 is transferred to both ends of the heat sink 90 at a constant speed while the heat dissipation operation is being performed.

In addition, since the cooling fins 92 aligned at one surface of the heat sink 90 are positioned in correspondence with the convection current direction of air, the air can easily flow within the front cover 10 and rear cover 20.

According to the embodiment of the present invention, the chassis base 40 of the chassis is made of a material having superior heat conductivity, such as aluminum. However, the heat generated by the driving chip 71 can be effectively dissipated even if the chassis base 40 is made of steel having heat conductivity lower than that of aluminum or plastic and having inferior heat conductivity. That is, the cooling efficiency can be improved even if the chassis base 40 is made of steel or plastic.

As described above, according to the plasma display device of the present invention, the heat sink used for cooling the driving chip provided on the signal line connecting the electrodes of the plasma display panel to the driving circuits may extend along the empty space formed between the front and rear covers, so that the length and the area of the heat sink may be enlarged, thereby significantly improving the cooling efficiency for the driving chip.

Although a preferred embodiment of the present invention has been described for illustrative purposes, those skilled in the art will appreciate that various modifications, additions and substitutions are possible without departing from the scope and spirit of the invention, as defined in the accompanying claims.

What is claimed is:

1. A plasma display device, comprising:
a front cover and a rear cover;
a plasma display panel installed at an inner portion of the front and rear covers;
a chassis attached to a rear surface of the plasma display panel, and including a chassis base and a reinforcement member;
a driving circuit installed on a rear surface of the chassis for driving the plasma display panel;
a signal line connecting the driving circuit with an electrode terminal installed at a peripheral area of the plasma display panel, and having a driving chip; and
a heat sink having a heat-conductive relationship with the driving chip so as to cool the driving chip;
wherein the heat sink extends toward an outer portion of the plasma display panel through an empty space formed between the front and rear covers.

2. The plasma display device as claimed in claim 1, wherein an outer peripheral portion of the rear cover is parallel to the front cover so as to form the empty space through which the heat sink extends.

3. The plasma display device as claimed in claim 2, wherein a lower end portion of the rear cover is downwardly bent and overlaps with a lower end of the front cover so that the lower end portion of the rear cover surrounds the lower end portion of the front cover, and wherein a screw is screw-coupled into an overlapped part between the front and rear covers in order to couple the front cover to the rear cover.

4. The plasma display device as claimed in claim 1, wherein the heat sink is installed on a cover plate for protecting the signal line having the driving chip.

5. The plasma display device as claimed in claim 4, wherein the driving chip is supported by the reinforcement member of the chassis, and is interposed between the reinforcement member and the cover plate.

6. The plasma display device as claimed in claim 5, further comprising heat-conductive media interposed between the driving chip and the reinforcement member of the chassis, and between the driving chip and the cover plate, respectively.

7. The plasma display device as claimed in claim 4, wherein the heat sink is installed on the cover plate so that the driving chip is positioned in correspondence with a center portion of the heat sink.

8. The plasma display device as claimed in claim 1, wherein the heat sink is made of aluminum.

9. The plasma display device as claimed in claim 1, wherein the heat sink is provided, on one surface thereof, with a plurality of upright-type cooling fins.

10. The plasma display device as claimed in claim 9, wherein the heat sink is installed on the cover plate in correspondence with a convection current direction of air.

11. The plasma display device as claimed in claim 1, wherein the chassis base is made of steel.

12. The plasma display device as claimed in claim 1, wherein the chassis base is made of plastic.
